(19) United States
(12) Patent Application Publication
(10) Pub. No.: US 2006/0109195 A1
(43) Pub. Date: May 25, 2006

(54) Shielded antenna

(76) Inventors: Tihiro Ohkawa, La Jolla, CA (US); Terence J. Wade, Sunningdale (GB)

Correspondence Address: NEIL K. NYDEGGER;NYDEGGER & ASSOCIATES, 348 Olive Street, San Diego, CA, 92103, US

(21) Appl. No.: 10/994,778

(22) Filed: Nov. 22, 2004

(51) Int. Cl. H01Q 1/42

(52) U.S. Cl. 343/872

(57) ABSTRACT

A shielded RF antenna system for generating a plasma from a starting material (e.g. a gas) includes a circularly shaped, loop antenna that surrounds a plasma region. A conductive, elongated screen element having an inner surface and an outer surface is wound as a helix around the loop antenna with the inner surface distanced from the antenna. Adjacent edges of the helical winding are overlapped and an insulator, such as a ceramic, is positioned between the overlapped edges to create a fluid tight seal therebetween. The screen element shields the electrostatic component of the electromagnetic field from the plasma region and prevents plasma from passing through the shield. In addition, the structure allows the insulator to be positioned between the overlapped edges where it is not directly exposed to the plasma.

### FIELD OF THE INVENTION

The present invention pertains generally to radiofrequency (RF) antennas and shields for RF antennas. More particularly, the present invention pertains to RF antennas for generating and maintaining a plasma. The present invention is particularly, but not exclusively, useful as an RF antenna system for use in generating a plasma that is shielded to prevent arcing.

### BACKGROUND OF THE INVENTION

By definition, ionization occurs whenever an electron is either added to, or subtracted from, an atom or molecule. Under specific conditions, ionization can result in the creation of a plasma (i.e. a highly ionized, gaseous discharge) in which there is no resultant (i.e. net) charge. Specifically, in addition to neutrals in the plasma, such as nonionized molecules or atoms, there will also be the same number of positive ions as there are negative ions (e.g. electrons). It is well known that once the plasma has been created, the ions can be influenced and used for a variety of purposes. For example, U.S. Pat. No. 6,096,220, which issued to Ohkawa for an invention entitled “Plasma Mass Filter,” and which is assigned to the same assignee as the present invention, uses a plasma for separating elements of different mass/charge ratios.

It is also well known that plasmas can be created when very strong electric fields are generated in gas-filled chambers. In order for ionization to occur, however, it is necessary that elements in the gas to be ionized are heated to a temperature that is equal to, or above, their respective ionization temperature. Stated differently, sufficient energy (typically measured in electron volts (eV)) must be generated in order to detach an electron from each nucleus of the element that is being ionized. This energy, more commonly known as ionization potential, will vary from element to element. For specific instances when a gas-filled chamber is used for the creation of a plasma, it is known that RF antennas are capable of generating the required ionization temperatures in the chamber.

One configuration that is capable of ionizing gases in a cylindrical shaped chamber is an arrangement that includes a plurality of generally circular, RF loop antennas. Specifically, these loop antennas can be respectively oriented in parallel planes, and coaxially aligned with each other. If alternating currents, at RF frequencies, are then passed through the loop antennas, and if the currents on adjacent loops flow in different directions (i.e. have different positive and negative potentials), the system is capable of generating the required ionization temperatures. Specifically, these temperatures will be generated in a substantially cylindrical shaped region that extends through the loops and along an axis that is defined by the loops.

It can happen, however, that when electrical currents in adjacent antenna loops are being driven by opposite voltage potentials, electrical arcing can occur. Specifically, it can happen that the resistance path from one electrode to another electrode may be less than the resistance path along the element. An arcing condition between adjacent RF antennas can thus be created that can be detrimental to the creation of a plasma in several ways. In addition to arcing between adjacent RF antennas, arcing can occur between an RF antenna and the plasma.

Heretofore, when RF antennas have been used to generate plasmas, special precautions have been taken. For example, in order to avoid arcing conditions, in the strong electric fields that are needed to create plasmas, the RF antennas have somehow been shielded from each other. Also, they have been shielded from the plasma. Specifically, in order to prevent arcing, the electrostatic component of the electromagnetic field generated by each RF antenna must be shielded. However, proper shielding has been difficult to implement.

One reason that shielding of RF antennas used for plasma generation has been so difficult is the fact that the use of insulating materials in a plasma environment is somewhat limited. Specifically, insulative materials are quickly degraded when they are directly exposed to a plasma, and, once degraded the insulative materials are no longer effective in preventing arcing. On the other hand, the use of conducting materials to shield RF antennas is not without its disadvantages. For example, a Faraday shield can be used to isolate the electrostatic component of the electromagnetic field generated by the antennas. In simple terms, a Faraday shield can be constructed using a plurality of axially aligned, conductive rods that are arranged as a cylinder and interposed between the plasma and each loop antenna. In use, the Faraday shield couples to the voltage of the RF antennas through a displacement current (i.e. capacitively) across the gaps formed between adjacent rods in the shield. However, because the rods are conductive, the shield itself produces an undesirable, secondary electromagnetic field in reaction to the field produced by the RF antennas. In addition, plasma is free to flow through the gaps where the plasma can contact and degrade insulative materials, such as the insulative materials that are typically used to line the plasma vessel housing.

In light of the above, it is an object of the present invention to provide a shielded RF antenna system for use in generating a plasma in a plasma chamber in which the shield prevents arcing between adjacent antennas in the system and arcing within the plasma. Still another object of the present invention is to provide a shielded RF antenna system for generating a plasma which minimizes any secondary electromagnetic field produced by the shield in reaction to the field produced by the RF antennas. Yet another object of the present invention is to provide a shielded RF antenna system for generating a plasma which minimizes direct exposure to the plasma of any insulative materials. Yet another object of the present invention is to provide an RF antenna for generating a plasma in a plasma chamber which is relatively easy to manufacture, is simple to use and is comparatively cost effective.

### SUMMARY OF THE INVENTION

The present invention is directed to a shielded RF antenna system for generating a plasma from a starting material, such as a gas. The system includes a loop antenna, which is typically circularly shaped, and surrounds a plasma region. A transmitter is attached to the loop antenna and configured to pass an RF signal along the loop. In response, the loop antenna generates an electromagnetic field that is directed toward the plasma region and includes both an electrostatic component and a magnetic component.

For the present invention, the system includes an elongated screen element having an inner surface and an outer surface. The screen element is made of a conductive material (e.g. metal) and is formed with opposed first and second edges that each extend between the inner and outer surface. With this structure, the screen element is wound as a helix around the loop antenna. In operation, the screen element shields the plasma region from the electrostatic component of the electromagnetic field generated by the antenna. This prevents arcing within the plasma and between adjacent RF antennas. Functionally, the helical screen element establishes a relatively large inductance path that is sufficient to prevent short-circuiting of the magnetic component of the electromagnetic field.

In greater structural detail, the screen element is wound on the antenna to surround the loop antenna with the inner surface of the screen element positioned at a distance from the antenna to establish a gap between the inner surface of the screen element and the antenna. Functionally, the gap is provided to electrically isolate the loop antenna from the screen element. In a typical embodiment, the gap can be filled with a dielectric material or a partial vacuum can be established in the gap to ensure the antenna is isolated from the screen material.

For the helical winding, each edge is formed with an extension allowing the first edge of the screen element to overlap the second edge. This overlap accommodates an insulator, such as a ceramic, which can be positioned between the first edge and the second edge of the screen element to create a fluid tight seal therebetween. With this cooperation of structure, the screen element shields the electrostatic component of the electromagnetic field from the plasma region and prevents the plasma from passing through the shield. In addition, the structure allows the insulator to be positioned between the edges where it is not directly exposed to the plasma (i.e. within line of sight of the plasma). As indicated above, the insulator would quickly degrade if the insulator was directly exposed to the plasma.

In a particular embodiment of the system, the screen element is a hollow structure which forms a conduit having a passageway. For this embodiment, the passageway extends the length of the helical winding to allow a cooling fluid to be passed through the conduit to cool the screen element. Similarly, the loop antenna can be formed as a substantially hollow tube, thus defining a lumen that can be used to pass a fluid to cool the loop antenna.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a shielded RF antenna system for generating a plasma from a starting material;

FIG. 2 is a front view of a shielded antenna;

FIG. 3 is a perspective view of a portion of a shielded antenna in partial cross-section as seen along line 3-3 in FIG. 2; and

FIG. 4 is a perspective view of another embodiment of shielded RF antenna system in which a plurality of antennas are shielded with a single, helically wound shield element.

### DESCRIPTION OF THE PREFERRED EMBODIMENTS

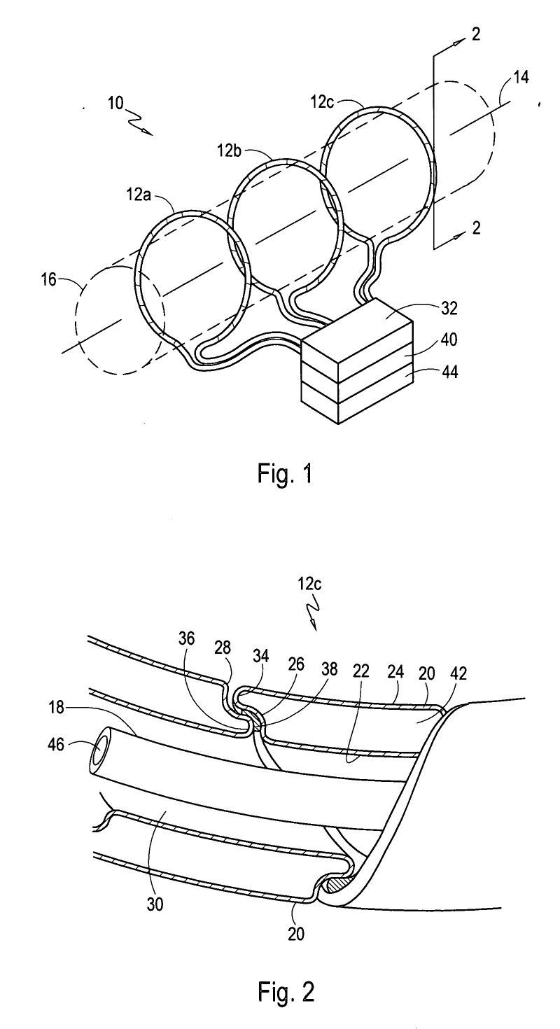

Referring to FIG. 1, a shielded RF antenna system for generating a plasma from a starting material, such as a gas, is shown and generally designated 10. As shown in FIG. 1, the system 10 includes a plurality of shielded loop antennas 12a-c which are co-axially arranged along a common axis 14. It can be further seen that each shielded loop antenna 12a-c surrounds a cylindrical shaped plasma region 16 where the starting material can be positioned for conversion to a plasma.

A more detailed understanding of the shielded loop antenna 12c can be obtained with reference to FIG. 2. As shown there, the shielded loop antenna 12c includes a substantially, circularly shaped loop antenna 18 and an elongated screen element 20. As FIG. 2 shows, the screen element 20 has an inner surface 22 and an outer surface 24. For the system 10, the screen element 20 is made of a conductive material (e.g. metal) and is formed with a first edge 26 and an opposed second edge 28 that each extend between the inner surface 22 and outer surface 24.

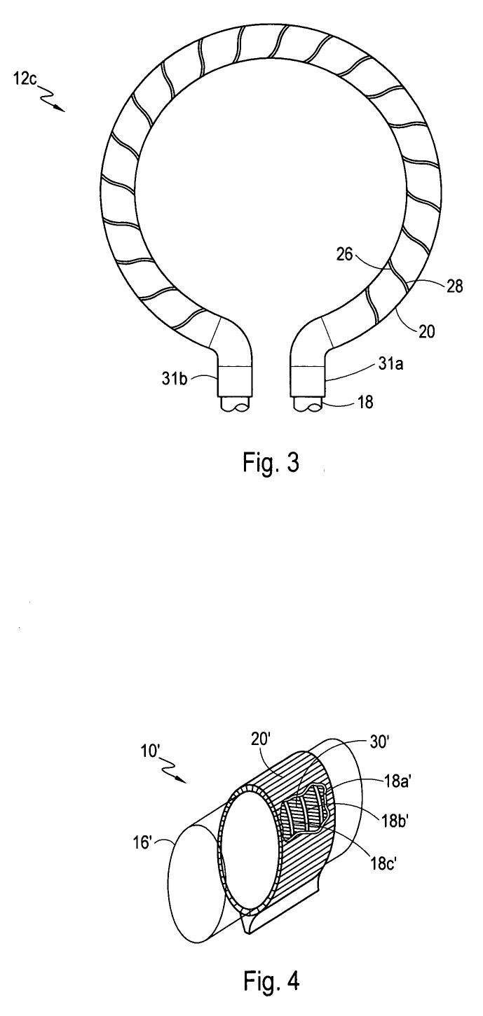

Cross-referencing FIG. 2 with FIG. 3, it can be seen that the screen element 20 is wound as a helix around the loop antenna 18. Specifically, as best seen in FIG. 2, the screen element 20 is wound on the antenna 18 to surround the loop antenna 18 with the inner surface 22 of the screen element 20 positioned at a distance from the antenna 18 to establish a gap 30 between the inner surface 22 and the antenna 18. Typically, the ends 31a,b are electrically connected together and grounded, and thus, a closed helical current path is established for the screen element 20. Although the screen element 20 shown in the FIGS. 1-3 is formed with a single winding, it is to be appreciated that the screen element 20 can be formed using two or more interlaced windings (not shown). Stated another way, the helical screen element 20 can begin and end with one or more windings.

For the system 10, the inner surface 22 is distanced from the antenna 18 to electrically isolate the loop antenna 18 from the screen element 20. In one embodiment, the gap 30 can be filled with a dielectric material. For example, a dielectric tape (not shown) can be wrapped on the antenna 18. Alternatively, a partial vacuum can be established in the gap 30 using a vacuum pump 32 (see FIG. 1) in fluid communication with the gap 30.

Continuing now with reference to FIG. 2, it can be seen that the first edge 26 is formed with an extension 34 and the second edge 28 is formed with an extension 36. As shown in FIG. 2, when the screen element 20 is wound on the antenna 18, the extension 34 is juxtaposed with the extension 36 causing the first edge 26 of the screen element 20 to overlap the second edge 28 of the screen element 20. FIG. 2 further shows that an insulator 38, which is typically a ceramic, is positioned between the extension 34 and the extension 36 to create a fluid tight seal therebetween. Cross-referencing FIG. 2 with FIG. 1, it is to be appreciated that the extension 34 prevents the direct exposure of the insulator 38 to the plasma region 16. Stated another way, the extension 34 is interposed between the insulator 38 and plasma region 16 preventing the plasma from reaching the insulator 38 along a direct, line-of-sight path. It is to be appreciated that the insulator 38 would quickly degrade if the insulator 38 was directly exposed to the plasma.

Continuing with cross-reference to FIGS. 1 and 2, it can be seen that each loop antenna 18 is electrically connected to a transmitter 40 which is configured to selectively pass relatively high frequency RF signals along each loop antenna 18 to ionize the starting material, for example, via helicon wave heating. In response to the signals from the transmitter 40, the loop antennas 18 generate an electromagnetic field that is directed toward the plasma region 16 that includes both an electrostatic component and a magnetic component. For the system 10, the screen element 20 shields the electrostatic component of the electromagnetic field from the plasma region 16 and prevents plasma and starting material from passing through the shield. More specifically, the screen element 20 shields the electrostatic component but does not interfere with the vector potential produced by the antenna 18. In particular, the helical screen element 20 establishes a relatively large inductance path that is sufficient to prevent short-circuiting of the magnetic component of the electromagnetic field. Those skilled in the pertinent art will appreciate that the pitch of the helical screen element 20 can be established to control the shielding of the electrostatic component.

As best seen in FIG. 2, the screen element 20 is a hollow structure which forms a conduit having a passageway 42. For the system 10, the passageway 42 extends the length of the helical winding. The passageway 42 is placed in fluid communication with a coolant pump 44 (see FIG. 1) to allow a cooling fluid to be passed through the passageway 42 to cool the screen element 20. FIG. 2 also shows that the loop antenna 18 is formed as a substantially hollow tube and defines a lumen 46. The lumen 46 is also placed in fluid communication with the coolant pump 44 (see FIG. 1) to allow a cooling fluid to be passed through the lumen 46 to cool the antenna 18.

FIG. 4 shows another embodiment of a system (designated system 10′) wherein a plurality of loop RF antennas 18a-c′ are coaxially arranged to surround a plasma region 16′ and are shielded by a single, helically wound screen element 20′. As shown, a gap cavity 30′ is established between the helically wound screen element 20′ to isolate the antennas 18a-c′ from the screen element 20′.

While the particular shielded antenna as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A shielded system which comprises:
a loop RF antenna surrounding a plasma region for directing an electromagnetic field toward the plasma region, wherein the electromagnetic field has an electrostatic component and a magnetic component; and
an elongated screen element, said screen element having an inner surface and an outer surface with opposed first and second edges extending therebetween, wherein said screen element is wound as a helix to surround said loop antenna, with the inner surface of said screen element positioned at a distance from the antenna to establish a gap therebetween to electrically isolate said loop antenna from said screen element, and with the first edge of said screen element overlapping the second edge thereof to use the screen element for shielding the electrostatic component of the electromagnetic field from the plasma region.

2. A system as recited in claim 1 wherein said screen element is formed with a conduit for passing a fluid therethrough to cool said screen element.

3. A system as recited in claim 1 further comprising:
an insulator positioned between the first edge and the second edge of the screen element to create a fluid tight seal therebetween; and
a means for creating a partial vacuum in the gap between said antenna and said screen element.

4. A system as recited in claim 3 wherein said insulator is a ceramic.

5. A system as recited in claim 1 further comprising a dielectric material positioned in the gap.

6. A system as recited in claim 5 wherein the dielectric material is a dielectric tape wrapped onto said loop antenna.

7. A system as recited in claim 1 wherein said loop antenna is a substantially hollow tube formed with a lumen for passing a fluid therethrough to cool said loop antenna.

8. A system as recited in claim 1 wherein said screen element is made of a metal.

9. A system as recited in claim 1 wherein the helix configuration of said screen element has a pitch, and the pitch is established to control shielding of the electrostatic component by said screen element.

10. A system as recited in claim 1 wherein the screen element establishes a helical path inductance sufficient to prevent short circuiting of the magnetic component of the electromagnetic field.

11. A system which comprises:
a plurality of loop antennas surrounding a substantially cylindrical shaped plasma region, wherein the plasma region defines an axis, and wherein said loop antennas are oriented in respective planes substantially perpendicular to the axis, with said plurality of loop antennas coaxially aligned therealong;
a means for activating said plurality of antennas to direct an electromagnetic field toward the plasma region, wherein the electromagnetic field has an electrostatic component and a magnetic component; and
an elongated screen element, said screen element having an inner surface and an outer surface with opposed first and second edges extending therebetween, wherein said screen element is wound in a helical configuration to create a gap cavity bounded by the inner surface of said screen element, with said plurality of loop antennas positioned in the gap cavity to have the inner surface of said screen element positioned at a distance from each antenna to electrically isolate said plurality of loop antennas from said screen element, and with the first edge of said screen element overlapping the second edge thereof to use the screen element for shielding the electrostatic component of the electromagnetic field from the plasma region.

12. A system as recited in claim 11 wherein said screen element is formed with a conduit for passing a fluid therethrough to cool said screen element.

13. A system as recited in claim 11 further comprising:
an insulator positioned between the first edge and the second edge of the screen element to create a fluid tight seal therebetween; and
a means for creating a partial vacuum in the gap cavity.

14. A system as recited in claim 13 wherein said insulator is a ceramic and said system further comprises a dielectric material positioned in the gap cavity.

15. A system as recited in claim 11 wherein each said loop antenna is a substantially hollow tube formed with a lumen for passing a fluid therethrough to cool said loop antenna.

16. A method for generating a plasma from a starting material, said method comprising the steps of:
surrounding the starting material with a loop RF antenna;
connecting said loop RF antenna to a transmitter for passing an RF signal through said antenna to direct an electromagnetic field toward the starting material, wherein the electromagnetic field has an electrostatic component and a magnetic component;
winding an elongated screen element around said loop RF antenna as a helix, said screen element having an inner surface and an outer surface with opposed first and second edges extending therebetween, with the inner surface of said screen element positioned at a distance from the antenna to establish a gap therebetween to electrically isolate said loop antenna from said screen element, and with the first edge of said screen element overlapping the second edge thereof to use the screen element for shielding the electrostatic component of the electromagnetic field from the starting material; and
activating said transmitter to generate the electromagnetic field and convert the starting material into plasma.

17. A method as recited in claim 16 wherein said screen element is formed with a conduit and said method further comprises the step of passing a fluid through the conduit to cool said screen element.

18. A method as recited in claim 16 further comprising the steps of:
positioning an insulator between the first edge and the second edge of said screen element to create a fluid tight seal therebetween; and
creating a partial vacuum in the gap between said antenna and said screen element.

19. A method as recited in claim 16 wherein said loop antenna is a substantially hollow tube formed with a lumen and said method further comprises the step of passing a fluid through said lumen to cool said loop antenna.

20. A method as recited in claim 16 wherein said screen element is made of a metal.
